(19) United States
(12) Patent Application Publication
(10) Pub. No.: US 2023/0091342 A1
(43) Pub. Date: Mar. 23, 2023

(54) ANTI-DAZZLE SYSTEM, ANTI-DAZZLE METHOD, AND RECORDING MEDIUM

(71) Applicant: Panasonic Intellectual Property Management Co., Ltd., Osaka (JP)

(72) Inventor: Kenji ARAKAWA, Kyoto (JP)

(21) Appl. No.: 17/902,809

(22) Filed: Sep. 3, 2022

(30) Foreign Application Priority Data
Sep. 14, 2021 (JP) 2021-149754

(51) Int. Cl. G02B 27/01; H04N 5/235; B60J 3/00

(52) U.S. Cl. CPC G02B 27/0172; H04N 5/2351; H04N 5/2354; B60J 3/007; G02B 2027/0118

(57) ABSTRACT

An anti-dazzle system includes a first obtainer, a second obtainer, a light reducer, and a control unit. The first obtainer obtains image data of a captured image of a surrounding environment from a first imaging sensor. The second obtainer obtains information for detection from which a movement of a head of a user is detectable, from the detection sensor. The light reducer includes a light reducing region that reduces an amount of light transmitted and is capable of moving the light reducing region in a predetermined range. The control unit detects a position of a light source included in the captured image of the surrounding environment based on the image data, and causes the light reducer to place the light reducing region between the light source and the head based on the position of the light source and the information for detection.

### CROSS REFERENCE TO RELATED APPLICATION

The present application is based on and claims priority of Japanese Patent Application No. 2021-149754 filed on Sep. 14, 2021. The entire disclosure of the above-identified application, including the specification, drawings and claims is incorporated herein by reference in its entirety.

### FIELD

The present disclosure relates to an anti-dazzle system, an anti-dazzle method, and a recording medium for preventing light from entering the eyes of a user from a light source.

### BACKGROUND

Patent Literature (PTL) 1 discloses an antidazzle apparatus for movable bodies. This antidazzle apparatus is capable of moving vertically and laterally relative to a user located in a movable body, and includes two dimmer portions each having a size that does not overlap with each other. One of the two dimmer portions can be positioned on a straight line linking a user's right eye and the sun, and the other of the two dimmer portions can positioned to a position on a straight line linking the user's left eye and the sun.

### CITATION LIST

### Patent Literature

PTL 1: Japanese Unexamined Patent Application Publication No. 2007-153135

### SUMMARY

### Technical Problem

The present disclosure provides an anti-dazzle system and others that make it easier to prevent light from entering the eyes of a user from a light source while suppressing enlargement of a light reducing region.

### Solution to Problem

An anti-dazzle system according to one aspect of the present disclosure includes: a first obtainer, a second obtainer, a light reducer, and a control unit. The first obtainer obtains image data of a captured image of a surrounding environment from a first imaging sensor. The second obtainer obtains information for detection from a detection sensor. The information for detection is information from which a movement of a head of a user is detectable. The light reducer includes a light reducing region and is capable of moving the light reducing region in a predetermined range. The light reducing region reduces an amount of light transmitted. The control unit detects a position of a light source included in the captured image of the surrounding environment based on the image data, and causes the light reducer to place the light reducing region between the light source and the head based on the position of the light source and the information for detection.

An anti-dazzle method according to one aspect of the present disclosure includes obtaining image data of a captured image of a surrounding environment from a first imaging sensor and obtaining information for detection from a detection sensor. The information for detection is information from which a movement of a head of a user is detectable. The anti-dazzle method also includes detecting a position of a light source included in the captured image of the surrounding environment based on the image data, and causing a light reducer including a light reducing region to place the light reducing region between the light source and the head based on the position of the light source and the information for detection. The light reducer is capable of moving the light reducing region in a predetermined range. The light reducing region reduces an amount of light transmitted.

A recording medium according to one aspect of the present disclosure is a non-transitory computer-readable recording medium having a program recorded thereon for causing one or more processors to execute the anti-dazzle method described above.

### Advantageous Effects

The anti-dazzle system and others according to the present disclosure are advantageous in that the anti-dazzle system and others make it easier to prevent light from entering the eyes of a user from a light source while suppressing enlargement of a light reducing region.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an overall configuration including an anti-dazzle system according to an embodiment.

FIG. 2 is a schematic diagram illustrating an exemplary use of the anti-dazzle system according to the embodiment.

FIG. 3 is a schematic diagram illustrating an example of a light reducer according to the embodiment.

FIG. 4 is a flowchart illustrating exemplary operation of the anti-dazzle system according to the embodiment.

FIG. 5 is a schematic diagram illustrating a head-mount device including the anti-dazzle system according to the embodiment.

### DESCRIPTION OF EMBODIMENT

### Underlying Knowledge Forming Basis of the Present Disclosure

First, the points that have been focused by the inventor will be described below.

The conventional antidazzle apparatus for movable bodies disclosed in PTL 1 includes a transmissive display (light reducer) disposed ahead of a driver (user) and two dimmer portions (light reducing regions) formed in the transmissive display. In this antidazzle apparatus, each of the two dimmer portions is positioned on a straight line linking a corresponding one of the driver's right eye or left eye and the sun to dim sunlight.

However, the antidazzle apparatus for movable bodies disclosed in PTL 1 does not take into consideration of a movement of the head of the user and a relative speed of the light source with respect to the user. Therefore, the antidazzle apparatus for movable bodies disclosed in PTL 1 has problems that the light reducing regions cannot fully prevent light from entering the user's eyes from the light source because the accuracy of the positions of the light reducing regions included in the light reducer is insufficient, and the light reducing regions need to be enlarged to compensate for the insufficient accuracy.

In view of the above, the inventor has created the present disclosure.

Hereinafter, an exemplary embodiment will be described in detail with reference to the drawings. However, description detailed more than necessary may be omitted. For example, detailed description of well-known matters or repeated description of the substantially same configurations may be omitted. This is to avoid unnecessarily redundant description and facilitate the understanding of those skilled in the art.

It should be noted that the inventor has provided the accompanying drawings and the following description in order to facilitate sufficient understanding of the present disclosure by those skilled in the art, and thus the accompanying drawings and the following description are not intended to limit the subject matters of the claims.

### EMBODIMENT

### [1. Overall Configuration]

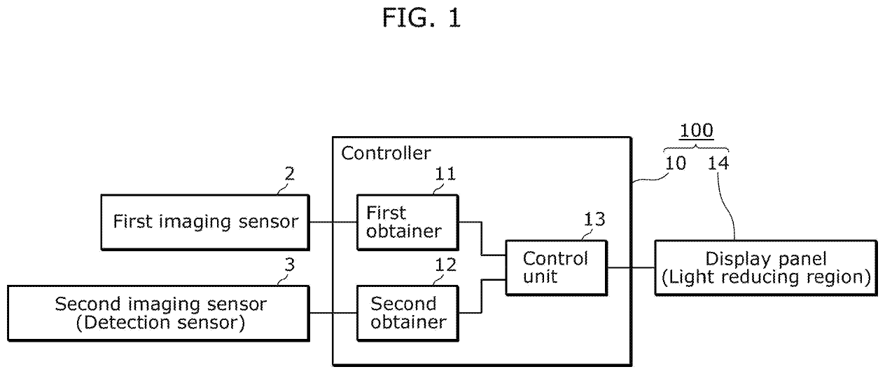

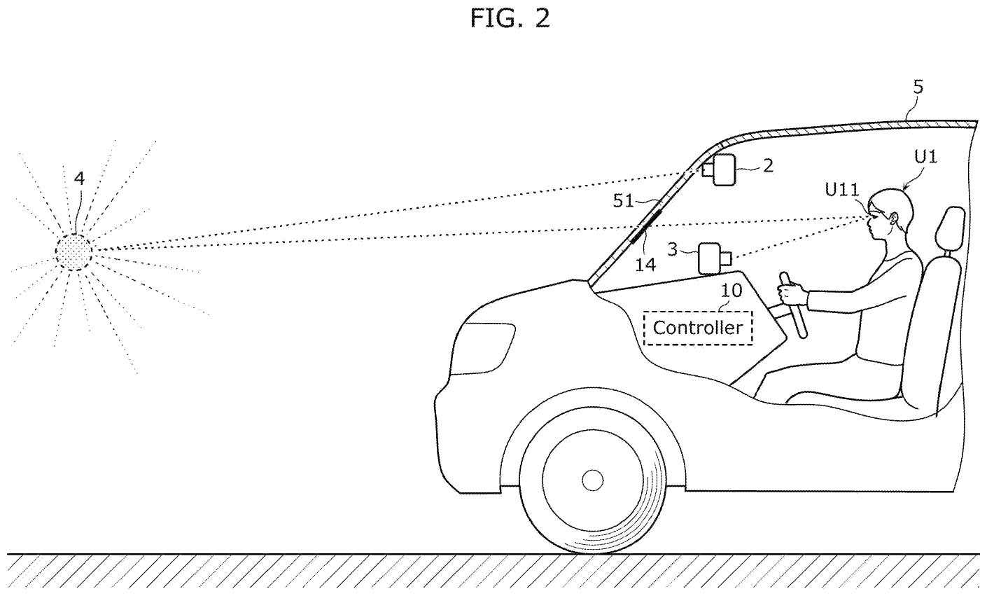

First, an overall configuration including anti-dazzle system 100 according to an embodiment will be described with reference to FIG. 1 and FIG. 2. FIG. 1 is a block diagram illustrating the overall configuration including anti-dazzle system 100 according to the embodiment. FIG. 2 is a schematic diagram illustrating an exemplary use of anti-dazzle system 100 according to the embodiment. Anti-dazzle system 100 is a system for preventing light from entering the eyes of user U1 from light source 4.

Here, light source 4 is, for example, sun 4. Note that light source 4 is not limited to sun 4. The light to be anti-dazzle by anti-dazzle system 100 may be light from any light source that emits light having an intensity that makes user U1 feel dazzled, for example, headlights of an oncoming car, and so on.

In the embodiment, among the structural elements of anti-dazzle system 100, controller 10 is provided in the dashboard of automobile 5, except for light reducer 14 (here, display panel 14), which will be described later. In other words, anti-dazzle system 100 is provided in movable body 5 (here, automobile 5). Therefore, user U1 is an occupant of movable body 5, for example, a driver. Movable body 5 is not limited to automobile 5, and may be other movable bodies, for example, an airplane.

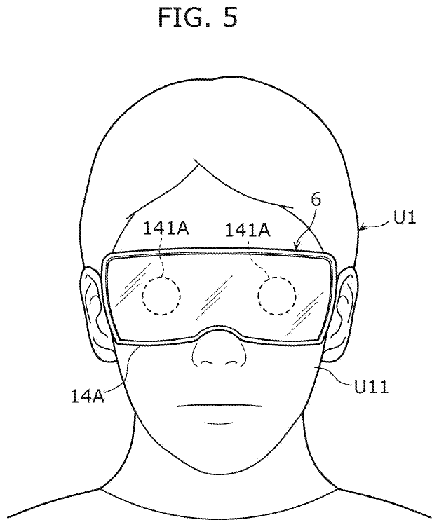

Note that although it will be described later, anti-dazzle system 100 does not need to be provided in movable body 5, and may be provided to head-mount device 6 (see FIG. 5) that is wearable on head U11 of user U1, such as extended reality (XR) glasses or a head-mounted display.

Anti-dazzle system 100 includes first obtainer 11, second obtainer 12, control unit 13, and light reducer 14. In the embodiment, first obtainer 11, second obtainer 12, and control unit 13 are structural elements of controller 10. Light reducer 14 is configured as a structural element separate from controller 10. Moreover, in the embodiment, automobile 5 is provided with first imaging sensor 2 and detection sensor 3 (here, second imaging sensor 3), in addition to anti-dazzle system 100. Note that first imaging sensor 2 and detection sensor 3 may be included as the structural elements of anti-dazzle system 100.

First obtainer 11 obtains image data of a captured image of a surrounding environment from first imaging sensor 2. In the embodiment, the surrounding environment is an external environment viewed through windshield 51 of automobile 5, i.e., a view ahead of automobile 5. In other words, the surrounding environment includes at least part of the field of view of user U1. First obtainer 11 is connected to first imaging sensor 2 via, for example, a communication cable, and receives and obtains image data transmitted from first imaging sensor 2 via wired communication. Note that first obtainer 11 may receive and obtain image data transmitted from first imaging sensor 2 via wireless communication based on, for example, a communication standard such as Bluetooth (registered trademark).

First imaging sensor 2 is provided, for example, on the ceiling inside automobile 5, and captures an image of the view ahead of automobile 5 through windshield 51. In the embodiment, first imaging sensor 2 is a device that converts optical information into electric information through photoelectric conversion, for example, a charge coupled device (CCD) image sensor or a complementary metal-oxide-semiconductor (CMOS) image sensor. Note that first imaging sensor 2 is not limited to a device that captures an image in a visible light region. First imaging sensor 2 may be a device that captures an image in a region other than the visible light, for example, a near infrared sensor, infrared sensor, or an ultraviolet sensor. Moreover, first imaging sensor 2 may include a plurality of first imaging sensors 2 to compensate for the angle of view equivalent to the field of view of user U1. Image data of an image of a surrounding environment captured by each first imaging sensor 2 may be obtained.

Second obtainer 12 obtains information for detection from which a position, an angle, and a direction of movement of head U11 of user U1 from detection sensor 3. In the embodiment, the information for detection is image data of a captured image of head U11 of user U1. Second obtainer 12 is connected to detection sensor 3 via, for example, a communication cable, and receives and obtains information for detection transmitted from detection sensor 3 via wired communication. Note that second obtainer 12 may receive and obtain information for detection transmitted from detection sensor 3 via wireless communication based on, for example, a communication standard such as Bluetooth (registered trademark).

Detection sensor 3 is provided, for example, on the dashboard of movable body 5 (automobile 5). Detection sensor 3 is second imaging sensor 3 that captures an image of head U11 of user U1 from inside movable body 5. Second imaging sensor 3 captures an image of head U11 of user U1 from the front. Therefore, the image data of an image captured by second imaging sensor 3 includes both eyes of user U1.

In the embodiment, second imaging sensor 3 is a device that converts optical information into electric information through photoelectric conversion, for example, a CCD image sensor or a CMOS image senor. Note that second imaging sensor 3 is not limited to a device that captures an image in a visible light region. Second imaging sensor 3 may be a device that captures an image in a region other than the visible light, for example, a near infrared sensor, infrared sensor, or an ultraviolet sensor.

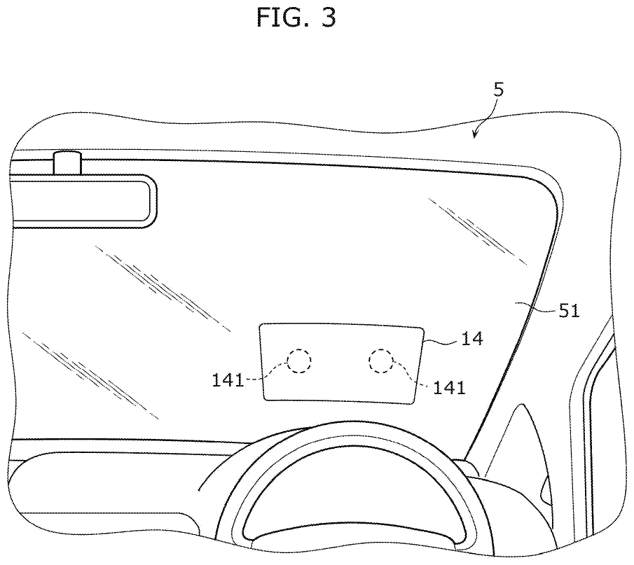

FIG. 3 is a schematic diagram illustrating an example of light reducer 14 according to the embodiment. As illustrated in FIG. 3, light reducer 14 is a device that includes light reducing region 141 that reduces the amount of light transmitted, and is capable of moving light reducing region 141 in a predetermined range. In the embodiment, light reducer 14 is display panel 14 that is provided to windshield 51 of movable body 5 (automobile 5) and is capable of controlling the amount of light transmitted in an arbitrary portion.

Display panel 14 is a transmissive display, such as a liquid crystal display or an organic electroluminescence (EL) display. Display panel 14 can change transmittance of light in an arbitrary region by being controlled by control unit 13. This enables display panel 14 to form light reducing region 141 that reduces light from light source 4 (sun 4) in an arbitrary portion. In the embodiment, two circular light reducing regions 141 are formed in display panel 14. Each of the two light reducing regions 141 corresponds to one of two eyes of user U1. Note that the number of light reducing regions 141 is not limited to two, and may be one depending on the distance and the angle with respect to light source 4. Furthermore, the shape of light reducing region 141 is not limited to a circular shape, and may be other shapes, for example, an elliptical shape.

Although display panel 14 is provided integrally with windshield 51 in the embodiment, display panel 14 may be provided separate from windshield 51. Moreover, although display panel 14 is provided only in front of user U1 in windshield 51 in the embodiment, display panel 14 may be provided in a region other than the front.

Control unit 13 is a processor, such as a central processing unit (CPU) or a micro-processing unit (MPU), and controls light reducer 14 based on the image data obtained by first obtainer 11 and the information for detection obtained by second obtainer 12. Note that control unit 13 is not limited to a CPU or an MPU, and may be, for example, a digital signal processor (DSP) for image processing or a processor specialized for computation using a neural network, such as a convolutional neural network (CNN) or a deep neural network (DNN). Control unit 13 may include a combination of these components.

Control unit 13 detects the position of light source 4 (sun 4) included in the captured image of the surrounding environment based on the image data obtained by first obtainer 11. In other words, the image data includes an image of an external environment viewed through windshield 51 of movable body 5 (automobile 5), i.e., a view ahead of automobile 5. Therefore, sun 4 may be included in the view ahead. Accordingly, control unit 13 performs appropriate image analysis processing on the image data to calculate the position (plane coordinates) of sun 4 in the image data. Note that since the image data is image data of an image captured from automobile 5 that is traveling, displacement of the position of sun 4 calculated from the image data is displacement in which a relative speed of sun 4 with respect to automobile 5, more specifically, a relative speed of sun 4 with respect to user U1 who is present in automobile 5 is taken into consideration.

Moreover, a global positioning system (GPS) receiver may be connected to controller 10. In this case, the detection accuracy of the position of sun 4 can be improved in the following manner. Control unit 13 identifies the position of automobile 5 based on a current time and the result of measurement by the GPS receiver, and calculates the traveling direction of automobile 5. Furthermore, control unit 13 obtains map information including undulation information of a road in the traveling direction and information necessary for calculating the trajectory of sun 4, for example, via the Internet.

Note that the map information does not need to include undulation information. If the map information includes at least whether the road in the traveling direction curves, the position of sun 4 can be detected while following the movement of user U1, i.e., shifting the user's focus on the portion where the road curves. Needless to say, the map information is desirable to include the undulation information to further improve the accuracy of detection of the position of sun 4, because the relative position of sun 5 with respect to user U1 changes according to undulations.

Moreover, control unit 13 causes light reducer 14 (display panel 14) to place light reducing region 141 between light source 4 and head U11 of user U1, based on the calculated position of light source 4 (sun 4) and the information for detection obtained by second obtainer 12. In other words, control unit 13 performs appropriate image analysis processing on the information for detection obtained by second obtainer 12, i.e., the image data of the captured image of head U11 of user U1 to calculate the position (plane coordinates) of head U11 in the image data. Specifically, control unit 13 calculates the position of both eyes of user U1 in head U11. Furthermore, control unit 13 forms two light reducing regions 141 on display panel 14 so that one of light reducing regions 141 is placed on a straight line connecting the calculated position of sun 4 and the position of the right eye of user U1 and the remaining one of light reducing regions 141 is placed on a straight line connecting the calculated position of sun 4 and the position of the left eye of user U1.

Here, in the embodiment, control unit 13 predicts the position of light source 4 and the position of head U11 of user U1 at a timing after the current time, based on the calculated position of light source 4 (sun 4) and the information for detection obtained by second obtainer 12. Moreover, control unit 13 causes light reducer 14 (display panel 14) to place, at the timing, light reducing regions 141 between light source 4 at the position predicted and head U11 at the position predicted.

In other words, ideally speaking, it is desirable that, at times at which control unit 13 detects the position of light source 4 and the position of head U11 of user U1, control unit 13 immediately calculates the positions of light reducing regions 141 and immediately causes light reducer 14 to change the positions of light reducing regions 141. However, in practice, there is a delay from the times at which the position of light source 4 and the position of head U11 of user U1 are detected to the time at which the positions of light reducing regions 141 are changed. Therefore, there may be cases where when the positions of light reducing regions 141 are changed, the positions of light source 4 and head U11 of user U1 deviate from the positions at the detected times, and the positions of light reducing regions 141 may deviate from the positions where light reducing regions 141 are supposed to be.

In view of this, in the embodiment, control unit 13 calculates (i) detection times necessary for detecting the positions of light source 4 and head U11 of user U1 and (ii) a speed of changing the positions or sizes of light reducing regions 141. Control unit 13 predicts the positions of light source 4 and head U11 at a timing after the times at which the positions of light source 4 and head U11 of user U1 are detected, based on these detection times and the changing speed, and causes light reducer 14 to place light reducing regions 141 between the predicted position of light source 4 and the predicted position of head U11. The position of head U11 of user U1 at the above-described timing is predicted based on the information for detection obtained by second obtainer 12.

Moreover, control unit 13 may detect the size of light source 4 included in the image based on the image data obtained by first obtainer 11 and change the sizes of light reducing regions 141 based on the size of light source 4 that has been detected. For example, when light source 4 is a pair of headlights of an oncoming car, light source 4 becomes larger in images as the oncoming car approaches movable body 5 (automobile 5). In this case, control unit 13 may enlarge each light reducing region 141 as light source 4 becomes larger in the images. Moreover, for example, light source 4 becomes smaller in images as the oncoming car moves away from automobile 5. In this case, control unit 13 may reduce each light reducing region 141 as light source 4 becomes smaller in the images.

Here, a third imaging sensor may further be included as detection sensor 3. The third imaging sensor is provided, for example, above user U1 in automobile 5, and captures an image of (detects) operation on the air conditioner or the car audio made by user U1. The third imaging sensor stores, in memory included in control unit 13, how much the position and the angle of head U11 of user U1 has been displaced according to the operation. When the third imaging sensor detects the same operation next time, control unit 13 refers to the position and the angle of head U11 of user U1 corresponding to the operation and reflects the position and the angle on the prediction of movement of head U11. In this manner, the prediction accuracy of the position of head U11 can be increased and light reducing regions 141 can be further narrowed.

Third imaging sensor is a device that converts optical information into electric information through photoelectric conversion, for example, a charge coupled device (CCD) image sensor or a complementary metal-oxide-semiconductor (CMOS) image sensor. Note that third imaging sensor is not limited to a device that captures an image in a visible light region. Third imaging sensor may be a device that captures an image in a region other than the visible light, for example, a near infrared sensor, infrared sensor, or an ultraviolet sensor. Furthermore, instead of the third imaging sensor, a computer, such as a CPU or an MPU, that controls an electronic device in the automobile, such as the air conditioner or the car audio, may detect operation performed on the air conditioner or the car audio.

### [2. Operation]

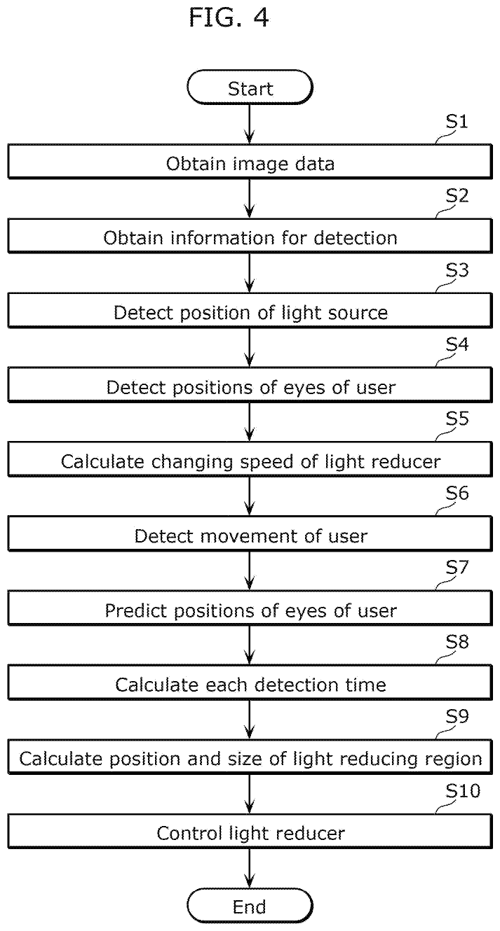

Operation (i.e., an anti-dazzle method) of anti-dazzle system 100 having the above configuration will be described below with reference to FIG. 4. FIG. 4 is a flowchart illustrating exemplary operation of anti-dazzle system 100 according to the embodiment. In the following, description is given assuming that first imaging sensor 2 captures an image of a surrounding environment at each predetermined time and detection sensor 3 (second imaging sensor 3) obtains information for detection (captures head U11 of user U1) at each predetermined time. Note that the timing at which first imaging sensor 2 captures an image of the surrounding environment and the timing at which detection sensor 3 obtains information for detection may be synchronous or asynchronous with each other.

First, first obtainer 11 obtains image data from first imaging sensor 2 each time first imaging sensor 2 captures an image of the surrounding environment (S1). Moreover, second obtainer 12 obtains information for detection from detection sensor 3 (second imaging sensor 3) each time detection sensor 3 obtains the information for detection (second imaging sensor 3 captures an image of head U11 of user U1) (S2). Note that the order of processes S1 and S2 may be reversed or processes S1 and S2 may be performed at the same time.

Next, control unit 13 detects the position of light source 4 based on the image data obtained by first obtainer 11 (S3). Moreover, control unit 13 detects the position of head U11 of user U1, in particular, the positions of the eyes of user U1, based on the information for detection obtained by second obtainer 12 (S4). Note that the order of processes S3 and S4 may be reversed or processes S3 and S4 may be performed at the same time.

Next, control unit 13 calculates a changing speed of light reducer 14, i.e., a speed necessary for changing the positions or the sizes of light reducing regions 141 (S5). Moreover, control unit 13 detects a movement of user U1 based on the information for detection obtained by second obtainer 12 (S6). Then, control unit 13 predicts the positions of the eyes of user U1 at a timing after the time at which the positions of the eyes of user U1 are detected, based on the detected positions of the eyes of user U1 and the detected movement of user U1 (S7). Note that the order of (i) process S5 and (ii) processes S6 and S7 may be reversed or process S5, and processes S6 and S7 may be performed at the same time. Moreover, in process S7, control unit 13 may predict the positions of the eyes of user U1 by referring to the movement of user U1 detected previously without waiting for the completion of process S6.

Next, control unit 13 calculates the detection time that has been taken for detection of the position of light source 4 and the detection time that has been taken for detecting the position of head U11 of user U1 (S8). Then, control unit 13 calculates the positions and sizes of light reducing regions 141 based on these detection times, the detected position of light source 4, the predicted positions of the eyes of user U1, and the calculated changing speed of light reducer 14 to place light reducing regions 141 between light source 4 and the eyes of user U1 (S9). Here, control unit 13 may increase the detection accuracy of light source 4 and the prediction accuracy of the positions of the eyes of user U1 by referring to, in addition to the information obtained by detecting the position of light source 4 (S3), (i) the speed of automobile 5, (ii) the traveling direction of automobile 5 that is based on the result of measurement by the GPS receiver, and (ii) the map information and information necessary for calculating the trajectory of sun 4 (light source 4) obtained, for example, via the Internet.

Note that control unit 13 does not need to calculate the detection times each time the position of light source 4 and the position of head U11 are detected. If the detection times are not calculated, control unit 13 may use, in process S9, the detection times that have been calculated last time. Moreover, for example, if the timing at which first imaging sensor 2 captures an image of the surrounding environment and the timing at which detection sensor 3 obtains information for detection are asynchronous with each other, control unit 13 may calculate the positions and the sizes of light reducing regions 141 in the following manner. In other words, control unit 13 may calculate, in process S9, the positions and the sizes of light reducing regions 141 by referring to the position of light source 4 that has been detected last time and the changing speed of light reducer 14 that has been calculated last time without waiting for the completion of processes S3 and S5. Moreover, control unit 13 may calculate, in process S9, the positions and the sizes of light reducing regions 141 by referring to the positions of the eyes of user U1 that have been predicted last time without waiting for the completion of processes S4, S6, and S7.

Subsequently, control unit 13 controls light reducer 14 according to the calculated positions and sizes of light reducing regions 141 (S10). After that, anti-dazzle system 100 repeats processes 51 to S10 described above during operation.

### [3. Advantages, etc.]

In the following, advantages of anti-dazzle system 100 (anti-dazzle method) according to the embodiment will be described.

As described above, the antidazzle apparatus for movable bodies disclosed in PTL 1 does not take into consideration of the relative speed of the light source with respect to the user and a movement of the head of the user. Therefore, since the accuracy of the positions of the light reducing regions is insufficient, the antidazzle apparatus for movable bodies disclosed in PTL 1 has problems that the light reducing regions cannot prevent light from entering the user's eyes from the light source and the light reducing regions need to be enlarged to compensate for the insufficient accuracy.

In contrast, anti-dazzle system 100 (anti-dazzle method) according to the embodiment takes into consideration of the relative speed of light source 4 with respect to user U1 and a movement of head U11 of user U1 to detect positions of light source 4 and head U11. Therefore, in the embodiment, positions of light source 4 and head U11 can be accurately detected compared with the case where the above information is not considered. As a result, the accuracy of the positions of light reducing regions 141 also increases.

Therefore, in the embodiment, light reducing regions 141 easily prevent light from entering the eyes of user U1 from light source 4 compared with the case where the above information is not considered. Furthermore, it is not necessary to enlarge light reducing regions 141 to compensate for the insufficient accuracy of the positions of light reducing regions 141. In other words, with the embodiment, the following advantages are provided: enlargement of light reducing regions 141 can be suppressed and it is easier to prevent light from entering the eyes of user U1 from light source 4.

### Variations

The above embodiment has been described as an example of the technique disclosed in the present application. However, the technique in the present disclosure is not limited to this. The technique in the present discloser is also applicable to embodiments as a result of appropriate modification, replacement, addition, and omission, for instance. Moreover, the structural elements described in the embodiment can be combined to create a new embodiment.

Therefore, variations of the embodiment will be described below as examples.

In the embodiment, anti-dazzle system 100 is provided in movable body 5 (automobile 5), but this example is not limiting. For example, anti-dazzle system 100 may be provided to head-mount device 6 that is wearable on head U11 of user U1, such as a head-mounted display or headset, or a helmet, as illustrated in FIG. 5. If head-mount device 6 is a helmet, anti-dazzle system 100 can also be applied to a driver of a motorbike, in addition to an occupant of an automobile.

FIG. 5 is a schematic diagram illustrating head-mount device 6 including anti-dazzle system 100 according to the embodiment. In the example illustrated in FIG. 5, head-mount device 6 is XR glasses and includes display panel 14A and controller 10 (not illustrated). Display panel 14A is a transmissive display as with display panel 14 in the embodiment, and is light reducer 14A including light reducing regions 141A. In other words, light reducer 14A is display panel 14A that is provided to head-mount device 6 and is capable of controlling the amount of light transmitted in an arbitrary portion. When user U1 wears head-mount device 6, user U1 can see an external environment through display panel 14A.

Although not illustrated in FIG. 5, first imaging sensor 2 is provided to head-mount device 6, and captures at least an image of ahead of user U1 who wears head-mount device 6, i.e., a view in a direction in which the eyes of user U1 are facing. Note that head-mount device 6 may further include one or more first imaging sensors 2 in addition to first imaging sensor 2 described above. In this case, control unit 13 may cause display panel 14A to display information about a view in a direction different from the ahead of user U1 by capturing an image of a view in a direction different from the ahead of user U1 by each of the one or more first imaging sensors 2. Furthermore, in this case, when light source 4 (sun 4) is detected in a direction other than the ahead of user U1, control unit 13 may cause display panel 14A to decrease the luminance of the information.

Moreover, when another display panel different from display panel 14A is included, control unit 13 may cause another display panel to display a video of one or more views captured by the one or more first imaging sensors 2. Also in this case, when light source 4 (sun 4) is detected in a direction other than the ahead of user U1, control unit 13 may cause the other display panel to decrease the luminance of the video.

Although not illustrated in FIG. 5, detection sensor 3 is an acceleration sensor provided to head-mount device 6. In other words, detection sensor 3 detects a movement of head U11 of user U1 by detecting acceleration of user U1 who wears head-mount device 6. Note that detection sensor 3 may be a triaxial acceleration sensor, or may further include a gyroscope sensor (angular velocity sensor). In this case, the accuracy of detecting the direction and the speed of the movement of head U11 of user U1 is be expected to increase.

Also, in head-mount device 6 described above, anti-dazzle system 100 causes display panel 14A to place light reducing regions 141 between light source 4 (sun 4) and both eyes of user U1. With this, user U1 is less likely to feel dazzled by light from light source 4 from the external environment and sees the video displayed on display panel 14A more easily.

In the embodiment, control unit 13 causes light reducer 14 to place each of light reducing regions 141 on a straight line connecting light source 4 and a corresponding one of two eyes of user U1, but this example is not limiting. For example, when there is a component that refracts light between light source 4 and user U1, control unit 13 may control light reducer 14 by taking into consideration of the refractive index of the component.

In the embodiment, control unit 13 causes light reducer 14 to change the positions of light reducing regions 141 in light reducer 14 (display panel 14), but this example is not limiting. For example, control unit 13 may cause light reducer 14 to change the position of light reducer 14 itself to change the positions of light reducing regions 141.

In the embodiment, light reducer 14 is display panel 14, but this example is not limiting. For example, light reducer 14 may be a shield component that can block light from light source 4. In this case, the entirety of shield component is light reducing region 141. Moreover, in this case, control unit 13 may change the position of light reducing region 141 by moving or rotating the blocking component by controlling an actuator.

In the embodiment, first imaging sensor 2 and detection sensor 3 are configured as two imaging sensors different from each other, but this example is not limiting. For example, first imaging sensor 2 and detection sensor 3 may be configured as a single imaging sensor, for example, by using an omnidirectional camera.

In the embodiment, movable body 5 is automobile 5, but this example is not limiting. For example, automobile 5 may be an airplane, a ship, a train, or the like.

Moreover, for example, in the embodiment, anti-dazzle system 100 is achieved as a single device except for light reducer 14, but may be achieved by a plurality of devices. If anti-dazzle system 100 is achieved by a plurality of devices, the structural elements included in anti-dazzle system 100 may be allocated to the plurality of devices in any manner. For example, part of the structural elements included in anti-dazzle system 100 in the embodiment may be included in a server. In other words, the present disclosure may be achieved by cloud computing or edge computing.

Moreover, for example, in the above embodiment, all or part of the structural elements of anti-dazzle system 100 except for light reducer 14 in the present disclosure may include dedicated hardware, or may be achieved by executing an appropriate software program for each structural element. Each structural element may be achieved as a result of a program execution unit of a CPU or processor or the like reading and executing a software program stored on a recording medium such as a hard disk drive (HDD) or semiconductor memory.

The structural elements of anti-dazzle system 100 except for light reducer 14 may include one or more electronic circuits. The one or more electronic circuits may be each a general-purpose circuit or a dedicated circuit.

The one or more electronic circuits may include, for example, a semiconductor device, an integrated circuit (IC), or a large scale integration (LSI). The IC or LSI may be integrated into a single chip or multiple chips. Due to a difference in the degree of integration, the electronic circuit referred here to as an IC or LSI may be referred to as a system LSI, very large scale integration (VLSI), or ultra large scale integration (ULSI). Furthermore, a field programmable gate array (FPGA) which is programmable after manufacturing of the LSI can be used for the same purposes.

Furthermore, these general and specific aspects may be achieved by a system, a device, a method, an integrated circuit, or a computer program. Alternatively, these may be achieved using a non-transitory computer-readable recording medium such as an optical disk, HDD, or semiconductor memory storing the computer program. Furthermore, the present disclosure may be achieved as a program for causing a computer to execute the anti-dazzle method according to the embodiment. Furthermore, this program may be recorded on a non-transitory computer-readable recording medium such as a computer readable CD-ROM or may be distributed via a communication network, such as the Internet.

As described above, the embodiment has been described above as an example of the technique disclosed in the present disclosure. For this purpose, accompanying drawings and detailed description are provided.

Therefore, the structural elements in the detailed description and the accompanying drawings may include not only the structural elements essential for the solution of the problem but also the structural elements not essential for the solution of the problem, to illustrate the above implementation. Therefore, the inclusion of such optional structural elements in the detailed description and the accompanying drawings therefore does not mean that these optional structural elements are essential structural elements.

The foregoing embodiment is intended to be illustrative of the technique disclosed in the present disclosure, and therefore various changes, replacements, additions, omissions, etc. can be made within the scope of the appended claims and their equivalents.

### Conclusion

As described above, anti-dazzle system 100 according to the embodiment includes first obtainer 11, second obtainer 12, light reducer 14 (14A), and control unit 13. First obtainer 11 obtains image data of a captured image of a surrounding environment from first imaging sensor 2. Second obtainer 12 obtains information for detection from detection sensor 3. The information for detection is information from which a movement of head U11 of user U1 is detectable. Light reducer 14 (14A) includes light reducing region 141 (141A) and is capable of moving light reducing region 141 (141A) in a predetermined range. Light reducing region 141 (141A) reduces an amount of light transmitted. Control unit 13 detects a position of light source 4 included in the captured image of the surrounding environment based on the image data, and causes light reducer 14 (14A) to place light reducing region 141 (141A) between light source 4 and head U11 based on the position of light source 4 and the information for detection.

With this, since the accuracy of the position of light reducing region 141 (141A) increases, light reducing region 141 (141A) prevent light from entering the eyes of user U1 from light source 4 more easily. Furthermore, it is not necessary to enlarge light reducing region 141 (141A) to compensate for insufficient accuracy of the positions of light reducing regions 141 (141A). In other words, the anti-dazzle system according to the present disclosure provides advantages that enlargement of light reducing region 141 (141A) can be suppressed and it is easier to prevent light from entering the eyes of user U1 from light source 4.

Moreover, for example, in anti-dazzle system 100, control unit 13 predicts a position of light source 4 and a position of head U11 at a timing after a current time based on the position of light source 4 and the information for detection, and causes light reducer 14 (14A) to place, at the timing, light reducing region 141 (141A) between light source 4 at the position predicted and head U11 at the position predicted.

This provides advantages, for example, the positional displacement of light reducing region 141 (141A) is easily prevented by taking into consideration of the positional displacement between light source 4 and head U11 of user U1 due to a delay from a time at which the position of light source 4 is detected to a time at which the position of light reducing region 141 (141A) is actually changed.

Moreover, for example, in anti-dazzle system 100, control unit 13 detects a size of light source 4 included in the captured image and changes a size of light reducing region 141 (141A) based on the size of light source 4 that has been detected.

This provides an advantage that the size of light reducing region 141 (141A) can be optimized according to the size of light source 4 in the image, and therefore the size of light reducing region 141 (141A) is easily kept to a minimum.

Moreover, for example, in anti-dazzle system 100, detection sensor 3 is second imaging sensor 3 that captures an image of the head from inside movable body 5 in which user U1 is present. Light reducer 14 is display panel 14 that is provided to windshield 51 of movable body 5 and is capable of controlling an amount of light transmitted in an arbitrary portion.

This provides advantages that user U1 is less likely to feel dazzled by light from light source 4 such as sun 4 when user U1 sees the external environment through windshield 51.

Moreover, for example, in anti-dazzle system 100, control unit 13 detects the position of light source 4, further based on (i) a traveling direction of movable body 5 in which user U1 is present, the traveling direction being based on a result of measurement by a global positioning system (GPS) receiver, and (ii) map information about a road in the traveling direction of movable body 5.

This provides an advantage that the detection accuracy of the position of light source 4 can be further increased.

Moreover, for example, in anti-dazzle system 100, detection sensor 3 further detects operation on an electronic device made by user U1 inside movable body 5 in which user U1 is present. Control unit 13 predicts a position of head U11 according to the operation on the electronic device made by user U1 that has been detected.

This provides advantages that the detection accuracy of the position of head U11 of user U1 can be further increased, and light reducing region 141 can be further narrowed.

Moreover, for example, in anti-dazzle system 100, first imaging sensor 2 is provided to head-mount device 6 that is wearable on head U11. Detection sensor 3 is an acceleration sensor provided to head-mount device 6. Light reducer 14A is display panel 14A that is provided to head-mount device 6 and is capable of controlling an amount of light transmitted in an arbitrary portion. When user U1 wears head-mount device 6, user U1 is capable of seeing an external environment through display panel 14A.

This provides an advantage that user U1 is less likely to feel dazzled by light from light source 4, such as sun 4, when user U1 sees the external environment through display panel 14A.

Moreover, an anti-dazzle method according to the embodiment includes obtaining image data of a captured image of a surrounding environment from first imaging sensor 2, and obtaining information for detection from detection sensor 3. The information for detection is information from which a movement of head U11 of user U1 is detectable. Furthermore, this anti-dazzle method includes detecting a position of light source 4 included in the captured image of the surrounding environment based on the image data, and causing light reducer 14 (14A) including a light reducing region 141 (141A) to place light reducing region 141 (141A) between light source 4 and head U11 based on the position of light source 4 and the information for detection. The light reducer 14 (14A) is capable of moving light reducing region 141(141A) in a predetermined range. The light reducing region 141 (141A) reduces an amount of light transmitted.

With this, since the accuracy of the position of light reducing region 141 (141A) increases, light reducing region 141 (141A) more easily prevent light from entering the eyes of user U1 from light source 4. Furthermore, light reducing region 141 (141A) does not need to be enlarged to compensate for insufficient accuracy of the position of light reducing region 141 (141A). In other words, this provides advantages that enlargement of light reducing region 141 (141A) can be suppressed and it is easier to prevent light from entering the eyes of user U1 from light source 4.

Moreover, a program according to the embodiment causes one or more processors to execute the anti-dazzle method described above.

With this, since the accuracy of the position of light reducing region 141 (141A) increases, light reducing region 141 (141A) more easily prevents light from entering the eyes of user U1 from light source 4. Furthermore, light reducing region 141 (141A) do not need to be enlarged to compensate for insufficient accuracy of the position of light reducing region 141 (141A). In other words, the anti-dazzle system according to the present disclosure provides advantages that enlargement of light reducing region 141 (141A) can be suppressed and it is easier to prevent light from entering the eyes of user U1 from light source 4.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to an environment in which a user may feel dazzled by light emitted from a light source.

1. An anti-dazzle system comprising:
a first obtainer that obtains image data of a captured image of a surrounding environment from a first imaging sensor;
a second obtainer that obtains information for detection from a detection sensor, the information for detection being information from which a movement of a head of a user is detectable;
a light reducer that includes a light reducing region and is capable of moving the light reducing region in a predetermined range, the light reducing region reducing an amount of light transmitted; and
a control unit that detects a position of a light source included in the captured image of the surrounding environment based on the image data, and causes the light reducer to place the light reducing region between the light source and the head based on the position of the light source and the information for detection.

2. The anti-dazzle system according to claim 1, wherein
the control unit predicts a position of the light source and a position of the head at a timing after a current time based on the position of the light source and the information for detection, and causes the light reducer to place, at the timing, the light reducing region between the light source at the position predicted and the head at the position predicted.

3. The anti-dazzle system according to claim 1, wherein
the control unit detects a size of the light source included in the captured image and changes a size of the light reducing region based on the size of the light source that has been detected.

4. The anti-dazzle system according to claim 1, wherein
the detection sensor is a second imaging sensor that captures an image of the head from inside a movable body in which the user is present, and
the light reducer is a display panel that is provided to a windshield of the movable body and is capable of controlling an amount of light transmitted in an arbitrary portion.

5. The anti-dazzle system according to claim 1, wherein
the control unit detects the position of the light source, further based on (i) a traveling direction of a movable body in which the user is present, the traveling direction being based on a result of measurement by a global positioning system (GPS) receiver, and (ii) map information about a road in the traveling direction of the movable body.

6. The anti-dazzle system according to claim 1, wherein
the detection sensor further detects operation on an electronic device made by the user inside a movable body in which the user is present, and
the control unit predicts a position of the head according to the operation on the electronic device made by the user that has been detected.

7. The anti-dazzle system according to claim 1, wherein
the first imaging sensor is provided to a head-mount device that is wearable on the head,
the detection sensor is an acceleration sensor provided to the head-mount device,
the light reducer is a display panel that is provided to the head-mount device and is capable of controlling an amount of light transmitted in an arbitrary portion, and
when the user wears the head-mount device, the user is capable of seeing an external environment through the display panel.

8. An anti-dazzle method comprising:
obtaining image data of a captured image of a surrounding environment from a first imaging sensor;
obtaining information for detection from a detection sensor, the information for detection being information from which a movement of a head of a user is detectable; and
detecting a position of a light source included in the captured image of the surrounding environment based on the image data, and causing a light reducer including a light reducing region to place the light reducing region between the light source and the head based on the position of the light source and the information for detection, the light reducer being capable of moving the light reducing region in a predetermined range, the light reducing region reducing an amount of light transmitted.

9. A non-transitory computer-readable recording medium having a program recorded thereon for causing one or more processors to execute:
the anti-dazzle method according to claim 8.
